(19) United States
(12) Patent Application Publication
(10) Pub. No.: US 2025/0058773 A1
(43) Pub. Date: Feb. 20, 2025

(54) MONITORING-CONTROL APPARATUS, METHOD, AND NON-TRANSITORY COMPUTER-READABLE MEDIUM

(71) Applicant: NEC Corporation, Minato-ku, Tokyo (JP)

(72) Inventors: Masayuki TAKEKAWA, Tokyo (JP); Kosei KOBAYASHI, Tokyo (JP); Masaaki TAKEUCHI, Tokyo (JP); Kazuki OGATA, Tokyo (JP); Nobuyuki TOZAWA, Tokyo (JP)

(73) Assignee: NEC Corporation, Minato-ku, Tokyo (JP)

(21) Appl. No.: 18/723,510

(22) PCT Filed: Mar. 4, 2022
(86) PCT No.: PCT/JP2022/009495

§ 371 Date: Jun. 24, 2024

(51) Int. Cl. B60W 30/095; G08G 1/16

(52) U.S. Cl. CPC B60W 30/095; G08G 1/16

(57) ABSTRACT

A monitoring-control apparatus according to the present disclosure can improve safety inside a vehicle. In the monitoring-control apparatus, a monitoring information acquisition unit acquires monitoring information including at least one item out of vehicle information, intra-vehicular information, and extra-vehicular information of a vehicle being a monitoring target. An avoidance action formulation unit formulates a plurality of avoidance actions for the vehicle to avoid a collision, based on the monitoring information. For each of the plurality of avoidance actions, a degree-of-damage calculation unit calculates a degree of damage to the inside of the vehicle by the avoidance action, based on the monitoring information. An avoidance action instruction unit selects an avoidance action from among the plurality of avoidance actions, based on the degree of damage, and instructs the vehicle on the selected avoidance action.

### TECHNICAL FIELD

The present invention relates to a monitoring-control apparatus, a method, and a non-transitory computer-readable medium.

### BACKGROUND ART

A vehicle control method according to Patent Literature 1 includes: acquiring attribute information for each passenger on board a vehicle; individually determining a fall risk of each passenger, based on the attribute information; tracking a high-risk person determined to have a high fall risk in the cabin; individually recognizing a state of the high-risk person in the cabin; and restricting travel of the vehicle, based on dynamic fall risk information determined from a shift of barycenter estimated by modeling of an individual high-risk person in a standing state as a pose included in a state of the high-risk person.

### CITATION LIST

### Patent Literature

Patent Literature 1: Japanese Unexamined Patent Application Publication No. 2020-003936

### SUMMARY OF INVENTION

### Technical Problem

A vehicle executes various avoidance actions during travel in order to avoid an accident and a collision. Damage such as a fall of a passenger on board the vehicle may occur depending on an executed avoidance action. Therefore, the vehicle desirably executes an avoidance action with a degree of damage to the inside of the vehicle taken into consideration. However, the technology according to Patent Literature 1 does not control a vehicle in such a way that the vehicle executes an avoidance action with a degree of damage to the inside of the vehicle into consideration, and therefore there is room for improvement in safety inside the vehicle.

In view of such an issue, an object of the present disclosure is to provide a monitoring-control apparatus, a method, and a non-transitory computer-readable medium that enable improved safety inside a vehicle.

### Solution to Problem

A monitoring-control apparatus according to the present disclosure includes:
a monitoring information acquisition unit configured to acquire monitoring information including at least one item out of vehicle information, intra-vehicular information, and extra-vehicular information of a vehicle being a monitoring target;
an avoidance action formulation unit configured to formulate a plurality of avoidance actions for the vehicle to avoid a collision, based on the monitoring information;
a degree-of-damage calculation unit configured to calculate a degree of damage to an inside of the vehicle for each of the plurality of avoidance actions, based on the monitoring information; and
an avoidance action instruction unit configured to select an avoidance action from among the plurality of avoidance actions, based on the degree of damage, and instruct the vehicle on a selected avoidance action.

A method according to the present disclosure includes, by a computer:
acquiring monitoring information including at least one item out of vehicle information, intra-vehicular information, and extra-vehicular information of a vehicle being a monitoring target;
formulating a plurality of avoidance actions for the vehicle to avoid a collision, based on the monitoring information;
calculating a degree of damage to an inside of the vehicle for each of the plurality of avoidance actions, based on the monitoring information; and
selecting an avoidance action from among the plurality of avoidance actions, based on the degree of damage, and instructing the vehicle on a selected avoidance action.

A program is stored on a non-transitory computer-readable medium according to the present disclosure, the program causing a computer to execute processing of:
acquiring monitoring information including at least one item out of vehicle information, intra-vehicular information, and extra-vehicular information of a vehicle being a monitoring target;
formulating a plurality of avoidance actions for the vehicle to avoid a collision, based on the monitoring information;
calculating a degree of damage to an inside of the vehicle for each of the plurality of avoidance actions, based on the monitoring information; and
selecting an avoidance action from among the plurality of avoidance actions, based on the degree of damage, and instructing the vehicle on a selected avoidance action.

### Advantageous Effects of Invention

The present disclosure can provide a monitoring-control apparatus, a method, and a non-transitory computer-readable medium that enable improved safety inside a vehicle.

### BRIEF DESCRIPTION OF DRAWINGS

FIG. 1 is a block diagram illustrating a configuration of a monitoring-control apparatus according to a first example embodiment;

FIG. 2 is a block diagram illustrating a configuration of a monitoring-control apparatus according to a second example embodiment;

FIG. 3 is a flowchart illustrating the operation of the monitoring-control apparatus according to the second example embodiment;

FIG. 4 illustrates examples of vehicle control and a damage evaluation value for an avoidance action of a vehicle 1A predicted in the monitoring-control apparatus according to the second example embodiment;

FIG. 5 is a block diagram illustrating a configuration of a monitoring-control apparatus according to a third example embodiment;

FIG. 6 is a flowchart illustrating the operation of the monitoring-control apparatus according to the third example embodiment;

FIG. 7 is a table illustrating examples of vehicle control and a damage evaluation value for an avoidance action of a vehicle 1B predicted in the monitoring-control apparatus according to the third example embodiment;

FIG. 8 is a table illustrating examples of a damage evaluation value for each combination of an avoidance action of the vehicle 1A and an avoidance action of the vehicle 1B that are predicted in the monitoring-control apparatus according to the third example embodiment; and

FIG. 9 is a block diagram illustrating a configuration of a computer according to the first, second, and third example embodiments.

### EXAMPLE EMBODIMENT

Specific example embodiments applied with the present disclosure will be described in detail below with reference to drawings. In every drawing, the same components are given the same signs, and repeated description thereof is omitted as needed for clarification of description.

### First Example Embodiment

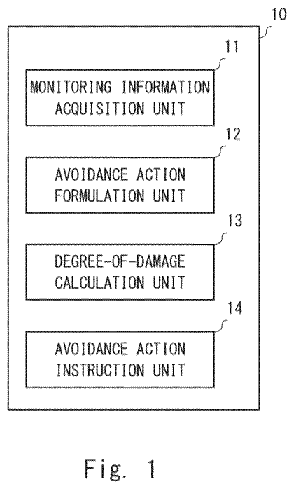

First, a configuration of a monitoring-control apparatus 10 according to a first example embodiment will be described with reference to FIG. 1.

The monitoring-control apparatus 10 includes a monitoring information acquisition unit 11, an avoidance action formulation unit 12, a degree-of-damage calculation unit 13, and an avoidance action instruction unit 14.

The monitoring information acquisition unit 11 acquires monitoring information including at least one item out of vehicle information, intra-vehicular information, and extra-vehicular information of a vehicle being a monitoring target. The avoidance action formulation unit 12 formulates a plurality of avoidance actions for a vehicle to avoid a collision, based on the monitoring information. For each of the plurality of avoidance actions, the degree-of-damage calculation unit 13 calculates a degree of damage to the inside of the vehicle by the avoidance action, based on the monitoring information. The avoidance action instruction unit 14 selects an avoidance action from among the plurality of avoidance actions, based on a degree of damage, and instructs the vehicle on the selected avoidance action.

Accordingly, the monitoring-control apparatus 10 according to the first example embodiment can control a vehicle in such a way that the vehicle executes an avoidance action based on a degree of damage to the inside of the vehicle.

### Second Example Embodiment

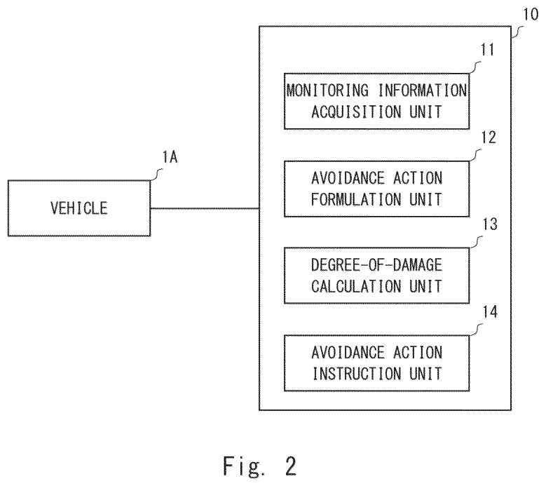

Next, a configuration of a monitoring-control apparatus 10 according to a second example embodiment will be described with reference to FIG. 2.

For example, a monitoring-control apparatus 10 is a server, communicates with a vehicle 1A, and remotely monitors and controls the vehicle 1A, as illustrated in FIG. 2. The monitoring-control apparatus 10 may be equipped on the vehicle 1A.

The vehicle 1A is a remotely controllable vehicle. For example, the vehicle 1A is an automated bus boarded by passengers. Note that without being limited to the aforementioned example, the vehicle 1A may be a movable body such as a train or an aircraft. Further, the monitoring-control apparatus 10 may remotely monitor and control a vehicle other than the vehicle 1A.

The monitoring-control apparatus 10 includes a monitoring information acquisition unit 11, an avoidance action formulation unit 12, a degree-of-damage calculation unit 13, and an avoidance action instruction unit 14 (referred to as functional components).

The monitoring information acquisition unit 11 acquires monitoring information of the vehicle 1A being a monitoring target. Monitoring information includes at least one item out of vehicle information, intra-vehicular information, and extra-vehicular information. Vehicle information is information about a vehicle. Intra-vehicular information is information about the inside of the vehicle. Extra-vehicular information is information about the outside of the vehicle.

The avoidance action formulation unit 12 formulates at least one type of avoidance action for the vehicle 1A to avoid a collision, based on monitoring information. Examples of a target of detection of a possibility of a collision include a vehicle 1B being a vehicle different from the vehicle 1A, a passerby, a utility pole on a road, and a roadside tree. Specifically, the avoidance action formulation unit 12 defines at least one type of avoidance action. The avoidance action formulation unit 12 defines vehicle control of the vehicle 1A for each avoidance action. Vehicle control refers to control for causing a vehicle to take a predetermined action. Examples of vehicle control include speed control of a vehicle and steering angle control of a vehicle. The avoidance action formulation unit 12 predicts a trajectory to be followed by the vehicle 1A when vehicle control defined by an avoidance action is executed. Note that the avoidance action formulation unit 12 may predict at least one type of trajectory of the vehicle 1A that is likely to be able to avoid a collision, back-calculate vehicle control of the vehicle 1A, such as speed control and steering angle control, based on the predicted trajectory of the vehicle 1A, and formulate at least one type of avoidance action of the vehicle 1A.

Further, for each defined avoidance action, the avoidance action formulation unit 12 determines whether the vehicle 1A can avoid a collision by the avoidance action, based on a predicted trajectory of the vehicle 1A.

The degree-of-damage calculation unit 13 calculates a degree of damage (also referred to as a damage evaluation value) for the inside of the vehicle 1A for each of at least one type of formulated avoidance action, based on monitoring information. A degree of damage includes a degree of damage to a person inside the vehicle 1A and a degree of damage to an object inside the vehicle 1A. Further, when a collision of the vehicle 1A is determined to be not avoidable by an avoidance action, the degree-of-damage calculation unit 13 reflects a degree of damage based on the collision in a degree of damage to the inside of the vehicle 1A.

The avoidance action instruction unit 14 selects an avoidance action from among at least one type of formulated avoidance action, based on a degree of damage, and instructs the vehicle 1A on the selected avoidance action. Specifically, the avoidance action instruction unit 14 selects an avoidance action with the lowest degree of damage from among at least one type of formulated avoidance action and instructs the vehicle 1A on the selected avoidance action.

Further, the avoidance action instruction unit 14 sets an allowable range of vehicle control of the vehicle 1A in an avoidance action, based on monitoring information. For example, an allowable range of vehicle control refers to an allowable range of the speed and the steering angle of the vehicle 1A in an avoidance action. Then, the avoidance action instruction unit 14 selects an avoidance action satisfying the allowable range from among a plurality of predicted avoidance actions. When a collision of the vehicle 1A is determined to be not avoidable by a selected avoidance action and increasing the upper limit of the allowable range is predicted to be able to reduce the damage compared with the case of a collision, such as avoiding a collision, the avoidance action instruction unit 14 may increase the upper limit of the allowable range.

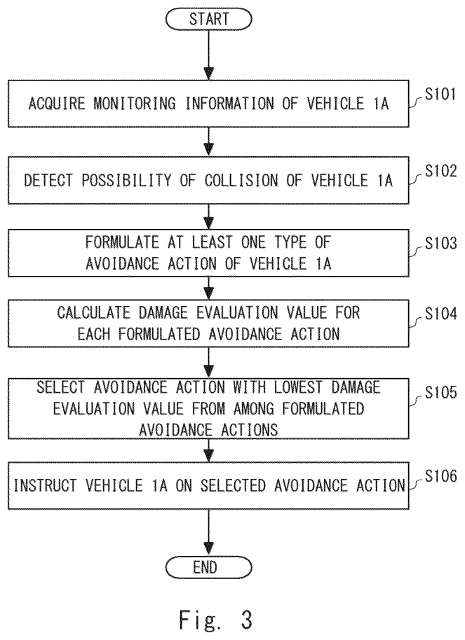

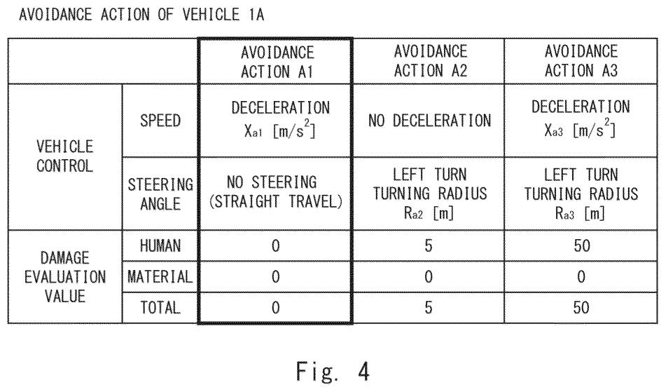

Next, the control operation on the vehicle 1A by the monitoring-control apparatus 10 according to the second example embodiment will be described with reference to FIG. 3 and FIG. 4. The vehicle 1A is a bus.

As illustrated in FIG. 3, first in Step S101, the monitoring information acquisition unit 11 in the monitoring-control apparatus 10 acquires monitoring information of the vehicle 1A being a monitoring target. The monitoring information includes at least one item out of vehicle information, intra-vehicular information, and extra-vehicular information. The vehicle information includes the travel speed of the vehicle, the positional information of the vehicle, and a degree of wear of a tire of the vehicle. The intra-vehicular information includes information about the number of passengers on board the vehicle, attribute information of the vehicle, and image capture information of the inside of the vehicle captured by a camera installed in the vehicle. The extra-vehicular information includes video image information of the outside of the vehicle captured by a camera installed in the vehicle and video image information captured by a camera installed at an intersection. The extra-vehicular information further includes information about status of a road surface on which the vehicle travels and weather information on the travel date.

Next, in Step S102, the avoidance action formulation unit 12 detects a possibility of a collision of the vehicle 1A, based on the monitoring information of the vehicle 1A. Examples of a target of detection of a possibility of a collision include a vehicle different from the vehicle 1A, a passerby, a utility pole on a road, and a roadside tree. For example, the avoidance action formulation unit 12 detects a possibility of a collision of the vehicle 1A from video image information of the outside of the vehicle captured by a camera installed in the vehicle 1A. Further, the avoidance action formulation unit 12 detects a possibility of a collision of the vehicle 1A from video image information captured by a camera installed at an intersection or the like.

Next, in Step S103, the avoidance action formulation unit 12 formulates at least one type of avoidance action for avoiding a collision of the vehicle 1A, based on the monitoring information of the vehicle 1A.

Specifically, the avoidance action formulation unit 12 defines at least one type of avoidance action. The avoidance action formulation unit 12 defines vehicle control, such as speed control and steering angle control, for each avoidance action. The avoidance action formulation unit 12 predicts a trajectory to be followed by the vehicle 1A when vehicle control defined by an avoidance action is executed.

More specifically, the avoidance action formulation unit 12 defines an avoidance action A1, an avoidance action A2, and an avoidance action A3 as illustrated in FIG. 4. The avoidance action A1 is collision avoidance by reasonable deceleration. The avoidance action A2 is collision avoidance by a leftward direction change. The avoidance action A3 is collision avoidance by deceleration and a sudden leftward direction change. The avoidance action formulation unit 12 defines vehicle control of the vehicle 1A, such as the speed and the steering angle of the vehicle 1A, in each of the avoidance action A1, the avoidance action A2, and the avoidance action A3. The speed control of the vehicle 1A and the steering angle control of the vehicle 1A in the avoidance action A1 are represented by control of deceleration at Xₐ₁ [m/s²] and steering being no steering (straight travel). The speed control of the vehicle 1A and the steering angle control of the vehicle 1A in the avoidance action A2 are represented by control of no deceleration and steering being a left turn with a turning radius of Rₐ₂ [m]. The speed control of the vehicle 1A and the steering angle control of the vehicle 1A in the avoidance action A3 are represented by control of deceleration at Xₐ₃ [m/s²] and steering being a left turn with a turning radius of Rₐ₃ [m]. The avoidance action formulation unit 12 predicts a trajectory to be followed by the vehicle 1A when the vehicle control defined by each of the avoidance action A1, the avoidance action A2, and the avoidance action A3 is executed.

Note that the avoidance action formulation unit 12 may predict at least one type of trajectory of the vehicle 1A that is likely to be able to avoid a collision, back-calculate vehicle control of the vehicle 1A, such as speed control and steering angle control, based on the predicted trajectory of the vehicle 1A, and formulate at least one type of avoidance action of the vehicle 1A.

The description returns to FIG. 3. Next, in Step S104, the degree-of-damage calculation unit 13 calculates a damage evaluation value for the inside of the vehicle 1A for each of the plurality of formulated avoidance actions, based on the monitoring information. For example, a damage evaluation value is the total of a human damage evaluation value for a person inside the vehicle and a material damage evaluation value for an object inside the vehicle.

Specifically, the degree-of-damage calculation unit 13 calculates a damage evaluation value for each of the avoidance action A1, the avoidance action A2, and the avoidance action A3, as illustrated in FIG. 4.

For the avoidance action A1, the degree-of-damage calculation unit 13 determines that an intra-vehicular damage such as a passenger fall does not occur in the vehicle 1A. Therefore, the degree-of-damage calculation unit 13 calculates a human damage evaluation value of the vehicle 1A by the avoidance action A1 to be 0 points and a material damage evaluation value to be 0 points. Then, the degree-of-damage calculation unit 13 calculates a damage evaluation value of the vehicle 1A by the avoidance action A1 to be 0 points.

For the avoidance action A2, the degree-of-damage calculation unit 13 determines that there is a possibility that one passenger falls inside the vehicle 1A. Therefore, when calculating a human damage evaluation value assuming 5 points per passenger falling inside the vehicle, the degree-of-damage calculation unit 13 calculates a human damage evaluation value of the vehicle 1A by the avoidance action A2 to be 5 points. Further, the degree-of-damage calculation unit 13 calculates a material damage evaluation value of the vehicle 1A by the avoidance action A2 of the vehicle 1A to be 0 points. Then, the degree-of-damage calculation unit 13 calculates a damage evaluation value of the vehicle 1A by the avoidance action A2 to be 5 points.

For the avoidance action A3, the degree-of-damage calculation unit 13 determines that there is a possibility that one passenger seriously falls and two passengers collide with each other inside the vehicle 1A. Therefore, when calculating a human damage evaluation value assuming 10 points per seriously falling passenger inside the vehicle and 20 points per passenger colliding with another passenger, the degree-of-damage calculation unit 13 calculates a human damage evaluation value by the avoidance action A3 of the vehicle 1A to be 50 points. Further, the degree-of-damage calculation unit 13 calculates a material damage evaluation value by the avoidance action A3 of the vehicle 1A to be 0 points. Then, the degree-of-damage calculation unit 13 calculates a damage evaluation value by the avoidance action A3 of the vehicle 1A to be 50 points.

The damage evaluation value by the avoidance action A1 is the lowest among the damage evaluation values by the avoidance actions A1 to A3.

Note that calculation of a damage evaluation value is not limited to simple totaling of a human damage evaluation value and a material damage evaluation value and may be performed by any other method. For example, a damage evaluation value may be acquired by adding up a human damage evaluation value and a material damage evaluation value each multiplied by a different weighting factor.

Further, the avoidance action formulation unit 12 may determine, for each defined avoidance action, whether the vehicle 1A can avoid a collision, based on a predicted trajectory of the vehicle 1A. When a collision of the vehicle 1A is determined to be unavoidable, the degree-of-damage calculation unit 13 may increase a damage evaluation value. For example, the degree-of-damage calculation unit 13 determines whether the vehicle 1A can avoid a collision, based on a predicted trajectory when the avoidance action A1 is executed. When a collision of the vehicle 1A is determined to be unavoidable, the degree-of-damage calculation unit 13 may increase the damage evaluation value of the avoidance action A1 by, for example, adding 100 points to the damage evaluation value.

The description returns to FIG. 3. Next, in Step S105, the avoidance action instruction unit 14 selects an avoidance action with the minimum damage evaluation value from among the plurality of formulated avoidance actions.

Specifically, the damage evaluation value for the avoidance action A1 in the vehicle 1A is 0 points, as illustrated in FIG. 4. The damage evaluation value of the vehicle 1A for the avoidance action A2 is 5 points. The damage evaluation value of the vehicle 1A for the avoidance action A3 is 50 points. Therefore, the avoidance action instruction unit 14 selects the avoidance action A1 with the lowest damage evaluation value from among the formulated avoidance actions being the avoidance action A1, the avoidance action A2, and the avoidance action A3.

Note that without being limited to selecting an avoidance action with the minimum damage evaluation value from among a plurality of predicted avoidance actions, the avoidance action instruction unit 14 may select an avoidance action with the second or third lowest damage evaluation value or the like. The avoidance action instruction unit 14 may select the avoidance action A2 with the second lowest damage evaluation value from among the avoidance action A1, the avoidance action A2, and the avoidance action A3 as illustrated in FIG. 4.

Further, the avoidance action instruction unit 14 may set an allowable range of vehicle control of the vehicle 1A in an avoidance action, based on monitoring information. An allowable range of control is an allowable range of speed control and steering angle control of the vehicle 1A in an avoidance action. Then, the avoidance action instruction unit 14 may select an avoidance action satisfying the allowable range from among a plurality of avoidance actions. When a collision of the vehicle 1A is determined to be not avoidable by the selected avoidance action, the avoidance action instruction unit 14 may increase the upper limit of the allowable range.

The description returns to FIG. 3. Next, in Step S106, the avoidance action instruction unit 14 instructs the vehicle 1A on the selected avoidance action. Then, the vehicle 1A executes the instructed avoidance action. Specifically, the avoidance action instruction unit 14 instructs the vehicle 1A on the selected avoidance action A1. The vehicle 1A executes the instructed avoidance action A1.

The avoidance action instruction unit 14 according to the present example embodiment directly controls the vehicle 1A by automated driving and causes the vehicle 1A to execute an avoidance action. Even when a driver exists, the avoidance action instruction unit 14 may instruct the vehicle 1A on an avoidance action and guide the driver to take the avoidance action by a driving assistance system or the like.

As described above, the monitoring-control apparatus 10 according to the second example embodiment controls the vehicle 1A in such a way as to cause the vehicle 1A to execute an avoidance action based on a degree of damage to the inside of the vehicle. For example, the monitoring-control apparatus 10 selects an avoidance action with a low degree of damage to the inside of the vehicle from among a plurality of avoidance actions and controls the vehicle 1A in such a way as to cause the vehicle 1A to execute the selected avoidance action. Accordingly, the monitoring-control apparatus 10 can improve safety inside the vehicle 1A.

Further, the monitoring-control apparatus 10 distinctively calculates a human damage evaluation value for a person inside the vehicle 1A and a material damage evaluation value for an object inside the vehicle 1A. Accordingly, the monitoring-control apparatus 10 can more precisely execute prediction of damage to the inside of the vehicle 1A.

Further, when determining whether a collision of the vehicle 1A is avoidable with a result that a collision of the vehicle 1A is unavoidable, the monitoring-control apparatus 10 calculates a damage evaluation value reflecting the collision. The monitoring-control apparatus 10 can more precisely execute prediction of damage to the inside of the vehicle 1A.

Further, the monitoring-control apparatus 10 sets an allowable range of vehicle control of the vehicle 1A in an avoidance action, based on monitoring information. The monitoring-control apparatus 10 selects an avoidance action satisfying the allowable range from among a plurality of predicted avoidance actions. In other words, the monitoring-control apparatus 10 can select an avoidance action based on a vehicle state, an intra-vehicular state, and an extra-vehicular state of the vehicle 1A, and can improve safety inside the vehicle 1A.

### Third Example Embodiment

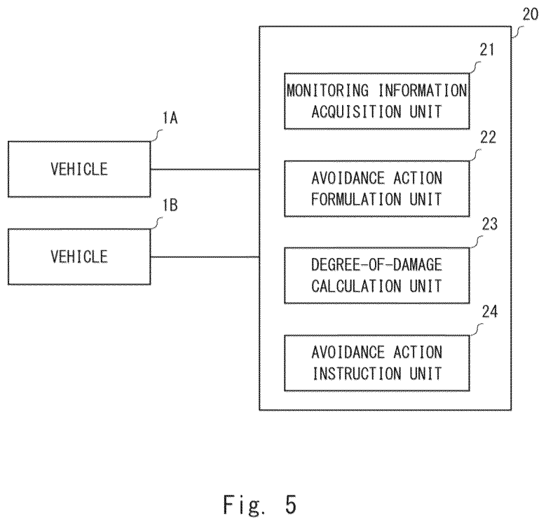

Next, a configuration of a monitoring-control apparatus 20 according to a third example embodiment will be described with reference to FIG. 5.

For example, the monitoring-control apparatus 20 is a server, communicates with a vehicle 1A (first vehicle 1A) and a vehicle 1B (second vehicle 1B), and remotely monitors and controls the vehicle 1A and the vehicle 1B, as illustrated in FIG. 5. The monitoring-control apparatus 10 may be equipped on at least one of the vehicle 1A and the vehicle 1B.

The vehicle 1A and the vehicle 1B are remotely controllable vehicles. For example, the vehicle 1A is a bus boarded by passengers. Further, for example, the vehicle 1B is a freight car loaded with freight. Note that without being limited to the aforementioned example, each of the vehicle 1A and the vehicle 1B may be a movable body such as a train or an aircraft. Further, the monitoring-control apparatus 10 may remotely monitor and control a vehicle other than the vehicle 1A and the vehicle 1B.

The monitoring-control apparatus 20 includes a monitoring information acquisition unit 21, an avoidance action formulation unit 22, a degree-of-damage calculation unit 23, and an avoidance action instruction unit 24 (referred to as functional components). While each functional component in the monitoring-control apparatus 20 has a configuration similar to that of each functional component in the monitoring-control apparatus 10 according to the second example embodiment, the function of each functional component is different.

The monitoring information acquisition unit 21 acquires monitoring information of the vehicle 1A and monitoring information of the vehicle 1B. Monitoring information includes at least one item out of vehicle information, intra-vehicular information, and extra-vehicular information. Vehicle information is information about a vehicle. Intra-vehicular information is information about the inside of the vehicle. Extra-vehicular information is information about the outside of the vehicle.

The avoidance action formulation unit 22 formulates a plurality of avoidance actions for the vehicle 1A to avoid a collision with the vehicle 1B, based on the monitoring information of the vehicle 1A. Specifically, the avoidance action formulation unit 22 defines at least one type of avoidance action. The avoidance action formulation unit 22 defines vehicle control of the vehicle 1A, such as speed control and steering angle control, for each avoidance action. The avoidance action formulation unit 22 predicts a trajectory to be followed by the vehicle 1A when vehicle control defined by an avoidance action is executed. Note that the avoidance action formulation unit 22 may predict at least one type of trajectory of the vehicle 1A that is likely to be able to avoid a collision with the vehicle 1B, back-calculate vehicle control of the vehicle 1A, such as speed control and steering angle control, based on the predicted trajectory, and formulate at least one type of avoidance action of the vehicle 1A.

Further, the avoidance action formulation unit 22 formulates a plurality of avoidance actions for the vehicle 1B to avoid a collision with the vehicle 1A, based on the monitoring information of the vehicle 1B. Specifically, the avoidance action formulation unit 22 defines at least one type of avoidance action. The avoidance action formulation unit 22 defines vehicle control of the vehicle 1B, such as speed control and steering angle control, for each avoidance action. The avoidance action formulation unit 22 predicts a trajectory to be followed by the vehicle 1B when vehicle control defined by an avoidance action is executed. Note that the avoidance action formulation unit 22 may predict at least one type of trajectory of the vehicle 1B that is likely to be able to avoid a collision with the vehicle 1A, back-calculate vehicle control of the vehicle 1B, such as speed control and steering angle control, based on the predicted trajectory, and formulate at least one type of avoidance action of the vehicle 1B.

Further, the avoidance action formulation unit 22 determines whether a collision between the vehicle 1A and the vehicle 1B can be avoided for each combination of an avoidance action of the vehicle 1A and an avoidance action of the vehicle 1B, based on a predicted trajectory of the vehicle 1A and a predicted trajectory of the vehicle 1B.

The degree-of-damage calculation unit 23 calculates a degree of damage to the inside of the vehicle 1A for each of a plurality of avoidance actions of the vehicle 1A. Further, the degree-of-damage calculation unit 23 calculates a degree of damage to the inside of the vehicle 1B for each of a plurality of avoidance actions of the vehicle 1B. A degree of damage to the inside of the vehicle 1A includes at least one of a degree of damage to a person inside the vehicle 1A and a degree of damage to an object inside the vehicle 1A. Further, a degree of damage to the inside of the vehicle 1B includes at least one of a degree of damage to a person inside the vehicle 1B and a degree of damage to an object inside the vehicle 1B.

Further, when the avoidance action formulation unit 22 determines that a collision between the vehicle 1A and the vehicle 1B is unavoidable, the degree-of-damage calculation unit 23 reflects a degree of damage based on whether a collision is avoidable in each of the degree of damage to the inside of the vehicle 1A and the degree of damage to the inside of the vehicle 1B.

From among combinations of an avoidance action of the vehicle 1A and an avoidance action of the vehicle 1B, the avoidance action instruction unit 24 selects a combination of avoidance actions, based on a degree of damage to the inside of the vehicle 1A and a degree of damage to the inside of the vehicle 1B. Specifically, from among the combinations of an avoidance action of the vehicle 1A and an avoidance action of the vehicle 1B, the avoidance action instruction unit 24 selects a combination of avoidance actions minimizing the total of a degree of damage to the inside of the vehicle 1A and a degree of damage to the inside of the vehicle 1B. Then, the avoidance action instruction unit 24 instructs each of the vehicle 1A and the vehicle 1B on an avoidance action related to the selected combination of avoidance actions.

Note that the avoidance action instruction unit 24 may set an allowable range of vehicle control of the vehicle 1A, such as the speed and the steering angle, and an allowable range of vehicle control of the vehicle 1B, based on monitoring information. Then, the avoidance action instruction unit 24 may select a combination of avoidance actions of the vehicle 1A and the vehicle 1B satisfying the allowable range of vehicle control and the allowable range of vehicle control of the vehicle 1B from among the combinations of an avoidance action of the vehicle 1A and an avoidance action of the vehicle 1B.

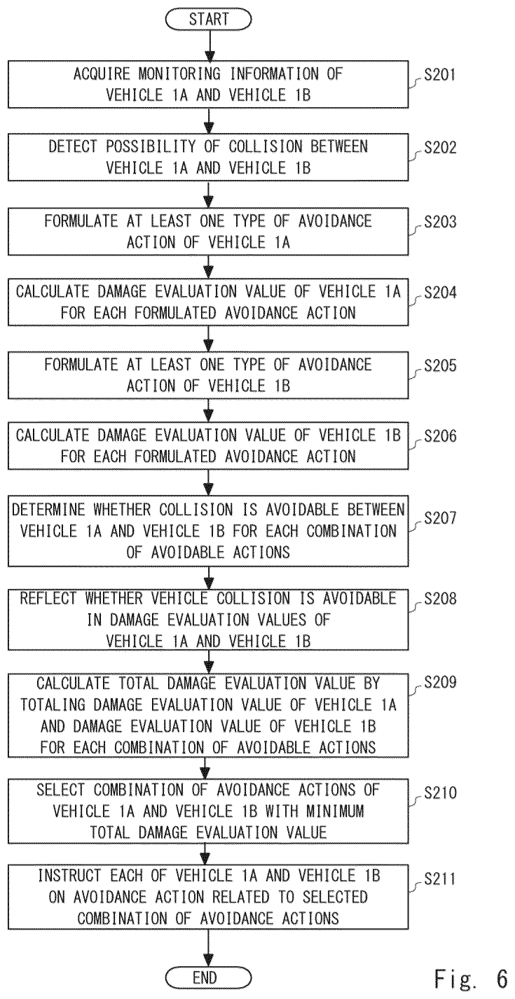

Next, the control operation on the vehicle 1A and the vehicle 1B by the monitoring-control apparatus 20 according to the third example embodiment will be described with reference to FIG. 6 to FIG. 8. The vehicle 1A is a bus boarded by passengers. The vehicle 1B is a freight car loaded with freight.

As illustrated in FIG. 6, first in Step S201, the monitoring information acquisition unit 21 in the monitoring-control apparatus 20 acquires monitoring information of the vehicle 1A being a monitoring target and monitoring information of the vehicle B. The monitoring information includes at least one item out of vehicle information, intra-vehicular information, and extra-vehicular information. The vehicle information includes the travel speed of the vehicle, positional information of the vehicle, and a degree of wear of a tire of the vehicle. The intra-vehicular information includes information about the number of passengers on board the vehicle, attribute information of the vehicle, and image capture information of the inside of the vehicle captured by a camera installed in the vehicle. The extra-vehicular information includes video image information of the outside of the vehicle captured by a camera installed in the vehicle and video image information captured by a camera installed at an intersection. The extra-vehicular information further includes information about status of a road surface on which the vehicle travels and weather information on the travel date.

Next, in Step S202, the avoidance action formulation unit 22 detects a possibility of a collision between the vehicle 1A and the vehicle 1B, based on the monitoring information of the vehicle 1A and the vehicle 1B. For example, the avoidance action formulation unit 22 detects a possibility of a collision between the vehicle 1A and the vehicle 1B from video image information of the outside of the vehicle captured by a camera installed in the vehicle 1A. Further, the avoidance action formulation unit 22 detects a possibility of a collision between the vehicle 1A and the vehicle 1B from video image information captured by a camera installed at an intersection or the like.

Next, in Step S203, the avoidance action formulation unit 22 formulates at least one type of avoidance action for avoiding a collision of the vehicle 1A, based on the monitoring information of the vehicle 1A.

Specifically, the avoidance action formulation unit 22 defines at least one type of avoidance action. The avoidance action formulation unit 22 defines vehicle control, such as speed control and steering angle control, for each avoidance action. The avoidance action formulation unit 22 predicts a trajectory to be followed by the vehicle 1A when vehicle control defined by an avoidance action is executed.

More specifically, the avoidance action formulation unit 22 defines the avoidance action A1, the avoidance action A2, and the avoidance action A3, as illustrated in FIG. 4. The avoidance action formulation unit 22 defines vehicle control of the vehicle 1A, such as the speed and the steering angle, in the avoidance action A1, the avoidance action A2, and the avoidance action A3. The avoidance action formulation unit 22 predicts a trajectory to be followed by the vehicle 1A when the vehicle control defined by each of the avoidance action A1, the avoidance action A2, and the avoidance action A3 is executed.

Note that the avoidance action formulation unit 22 may predict at least one type of trajectory of the vehicle 1A that is likely to be able to avoid a collision with the vehicle 1B, back-calculate vehicle control of the vehicle 1A, such as speed control and steering angle control, based on the predicted trajectory, and formulate at least one type of avoidance action of the vehicle 1A.

The description returns to FIG. 6. Next, in Step S204, the degree-of-damage calculation unit 23 calculates a damage evaluation value for the inside of the vehicle 1A for each formulated avoidance action, based on the monitoring information. The damage evaluation value is the total of a human damage evaluation value for a person inside the vehicle and a material damage evaluation value for an object inside the vehicle.

Specifically, the degree-of-damage calculation unit 23 calculates a damage evaluation value of the vehicle 1A for each of the avoidance action A1, the avoidance action A2, and the avoidance action A3, as illustrated in FIG. 4. The damage evaluation value of the vehicle 1A for the avoidance action A1 is 0 points. The damage evaluation value of the vehicle 1A for the avoidance action A2 is 5 points. The damage evaluation value of the vehicle 1A for the avoidance action A3 is 50 points.

The description returns to FIG. 6. Next, in Step S205, the avoidance action formulation unit 22 formulates at least one type of avoidance action for avoiding a collision of the vehicle 1B, based on the monitoring information of the vehicle 1B. Specifically, the avoidance action formulation unit 22 defines at least one type of avoidance action. The avoidance action formulation unit 22 defines vehicle control, such as speed control and steering angle control, for each avoidance action. The avoidance action formulation unit 22 predicts a trajectory to be followed by the vehicle 1B when vehicle control defined by an avoidance action is executed.

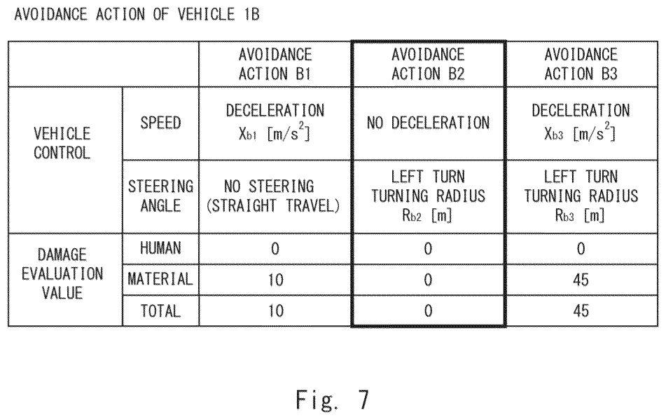

More specifically, the avoidance action formulation unit 22 defines an avoidance action B1, an avoidance action B2, and an avoidance action B3 as illustrated in FIG. 7. The avoidance action B1 is collision avoidance by sudden deceleration. The avoidance action B2 is collision avoidance by a leftward direction change. The avoidance action B3 is collision avoidance by sudden deceleration and a sudden leftward direction change. The avoidance action formulation unit 22 defines vehicle control of the vehicle 1B, such as the speed and the steering angle, in each of the avoidance action B1, the avoidance action B2, and the avoidance action B3. The speed control of the vehicle 1B and the steering angle control of the vehicle 1B in the avoidance action B1 are represented by control of deceleration at X_{b1} [m/s²] and steering being no steering (straight travel). The speed control of the vehicle 1B and the steering angle control of the vehicle 1B in the avoidance action B2 are represented by control of no deceleration and steering being a left turn with a turning radius of R_{b2} [m]. The speed control of the vehicle 1B and the steering angle control of the vehicle 1B in the avoidance action B3 are represented by control of deceleration at X_{b3} [m/s²] and steering of a left turn with a turning radius of R_{b3} [m]. The avoidance action formulation unit 22 predicts a trajectory to be followed by the vehicle 1B when vehicle control defined by each of the avoidance action B1, the avoidance action B2, and the avoidance action B3 is executed.

Note that the avoidance action formulation unit 22 may predict at least one type of trajectory of the vehicle 1B that is likely to be able to avoid a collision with the vehicle 1A, back-calculate vehicle control of the vehicle 1B, such as speed control and steering angle control, based on the predicted trajectory, and formulate at least one type of avoidance action of the vehicle 1B.

The description returns to FIG. 6. Next, in Step S206, the degree-of-damage calculation unit 23 calculates a damage evaluation value for the inside of the vehicle 1B for each formulated avoidance action, based on the monitoring information. The damage evaluation value is the total of a human damage evaluation value and a material damage evaluation value.

Specifically, the degree-of-damage calculation unit 23 calculates a damage evaluation value for each of the avoidance action B1, the avoidance action B2, and the avoidance action B3, as illustrated in FIG. 7.

For the avoidance action B1, the degree-of-damage calculation unit 23 predicts that freight collapses and five pieces of baggage are slightly damaged inside the vehicle 1B. Therefore, when calculating a material damage evaluation value assuming 2 points per piece of slightly damaged baggage, the degree-of-damage calculation unit 23 calculates a material damage evaluation value of the vehicle 1B by the avoidance action B1 to be 10 points. Further, the degree-of-damage calculation unit 23 calculates a human damage evaluation value of the vehicle 1B by the avoidance action B1 to be 0 points. Then, the degree-of-damage calculation unit 23 calculates a damage evaluation value of the vehicle 1B by the avoidance action B1 to be 10 points.

For the avoidance action B2, the degree-of-damage calculation unit 23 predicts that intra-vehicular damage such as collapse of freight does not occur in the vehicle 1B. Therefore, the degree-of-damage calculation unit 23 calculates a human damage evaluation value and a material damage evaluation value of the vehicle 1B by the avoidance action B2 to be 0 points and 0 points, respectively. Then, the degree-of-damage calculation unit 23 calculates a damage evaluation value of the vehicle 1B by the avoidance action B2 to be 0 points.

For the avoidance action B3, the degree-of-damage calculation unit 23 predicts that freight collapses and 15 pieces of baggage are seriously damaged inside the vehicle 1B. Therefore, when calculating a material damage evaluation value assuming 3 points per piece of seriously damaged baggage, the degree-of-damage calculation unit 23 calculates a material damage evaluation value of the vehicle 1B by the avoidance action B3 to be 45 points. Further, the degree-of-damage calculation unit 23 calculates a human damage evaluation value of the vehicle 1B by the avoidance action B3 to be 0 points. Then, the degree-of-damage calculation unit 23 calculates a damage evaluation value of the vehicle 1B by the avoidance action B3 to be 45 points.

The damage evaluation value for the avoidance action B1 is the lowest among the damage evaluation values for the avoidance actions B1 to B3.

Note that calculation of a damage evaluation value is not limited to simple totaling of a human damage evaluation value and a material damage evaluation value and may be performed by any other method. For example, a damage evaluation value may be acquired by adding up a human damage evaluation value and a material damage evaluation value each multiplied by a different weighting factor.

The description returns to FIG. 6. Next, in Step S207, for each combination of an avoidance action of the vehicle 1A and an avoidance action of the vehicle 1B, the avoidance action formulation unit 22 determines whether a collision between the vehicle 1A and the vehicle 1B is avoidable, based on a trajectory of the vehicle 1A and a trajectory of the vehicle 1B in predicted avoidance actions.

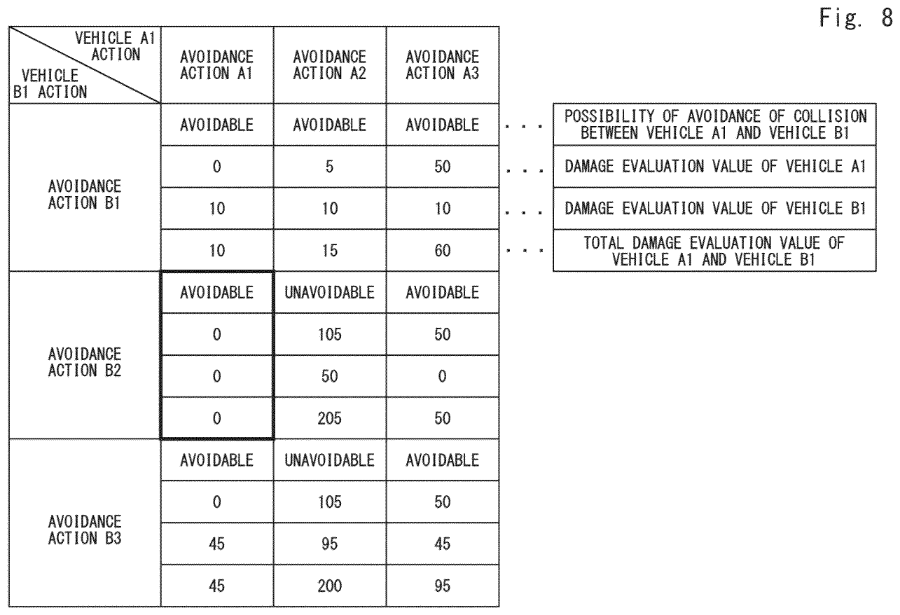

Specifically, the avoidance action formulation unit 22 uses trajectories for the avoidance actions A1 to A3 and trajectories of the vehicle 1B for the avoidance actions B1 to B3, as illustrated in FIG. 8. The avoidance action formulation unit 22 determines whether a collision between the vehicle 1A and the vehicle 1B is avoidable for each combination of the avoidance actions A1 to A3 of the vehicle 1A and the avoidance actions B1 to B3 of the vehicle 1B. For example, the avoidance action formulation unit 22 determines that a collision between the vehicle 1A and the vehicle 1B is avoidable for a combination of the avoidance action A1 of the vehicle 1A and the avoidance action B2 of the vehicle 1B. Further, the avoidance action formulation unit 22 determines that a collision between the vehicle 1A and the vehicle 1B is unavoidable for a combination of the avoidance action A2 of the vehicle 1A and the avoidance action B2 of the vehicle 1B.

The description returns to FIG. 6. Next, in Step S208, the degree-of-damage calculation unit 23 reflects whether a collision between the vehicle 1A and the vehicle 1B is avoidable in damage evaluation values of the vehicle 1A and the vehicle 1B. Specifically, when a collision between the vehicle 1A and the vehicle 1B is determined to be unavoidable, the degree-of-damage calculation unit 23 increases the damage evaluation values. Note that the degree-of-damage calculation unit 23 may set an increased value of a damage evaluation value when a person is on board the vehicle greater than an increased value of a damage evaluation value when a person is not on board the vehicle. On the other hand, when a collision between the vehicle 1A and the vehicle 1B is determined to be avoidable, the degree-of-damage calculation unit 23 does not increase the damage evaluation values.

Specifically, the degree-of-damage calculation unit 23 reflects whether a collision between the vehicle 1A and the vehicle 1B is avoidable in damage evaluation values of the vehicle 1A and the vehicle 1B, as illustrated in FIG. 8. For example, the avoidance action formulation unit 22 determines that a collision between the vehicle 1A and the vehicle 1B is unavoidable for a combination of the avoidance action A2 of the vehicle 1A and the avoidance action B2 of the vehicle 1B. Therefore, the degree-of-damage calculation unit 23 sets a damage evaluation value of the vehicle 1A for the avoidance action A2 to 105 points by adding 100 points for a collision being unavoidable to a damage evaluation value of 5 points. Therefore, the degree-of-damage calculation unit 23 sets a damage evaluation value of the vehicle 1B for the avoidance action B2 to 50 points by adding 50 points for a collision being unavoidable to 0 points.

The description returns to FIG. 6. Next, in Step S209, the degree-of-damage calculation unit 23 calculates a total damage evaluation value by totaling a damage evaluation value of the vehicle 1A and a damage evaluation value of the vehicle 1B for each combination of an avoidance action of the vehicle 1A and an avoidance action of the vehicle 1B.

Specifically, the degree-of-damage calculation unit 23 calculates a total damage evaluation value by totaling a damage evaluation value of the vehicle 1A and a damage evaluation value of the vehicle 1B for each combination of the avoidance actions A1 to A3 of the vehicle 1A and the avoidance actions B1 to B3 of the vehicle 1B, as illustrated in FIG. 8. For example, the degree-of-damage calculation unit 23 calculates a total damage evaluation value to be 0 points for a combination of the avoidance action A1 of the vehicle 1A and the avoidance action B2 of the vehicle 1B. Further, the degree-of-damage calculation unit 23 calculates a total damage evaluation value to be 205 points for a combination of the avoidance action A2 of the vehicle 1A and the avoidance action B2 of the vehicle 1B.

The description returns to FIG. 6. Next, in Step S210, the avoidance action instruction unit 24 selects a combination of avoidance actions of the vehicle 1A and the vehicle 1B with the lowest total damage evaluation value of the vehicle 1A and the vehicle 1B from among the combinations of an avoidance action of the vehicle 1A and an avoidance action of the vehicle 1B.

Specifically, the avoidance action instruction unit 24 selects a combination of the avoidance action A1 of the vehicle 1A and the avoidance action B2 of the vehicle 1B with the lowest total damage evaluation value of the vehicle 1A and the vehicle 1B, as illustrated in FIG. 8.

Note that without being limited to selecting a combination of avoidance action with the minimum damage evaluation value from among combinations of avoidance actions, the avoidance action instruction unit 24 may select a combination of avoidance actions with the second or third lowest damage evaluation value or the like. For example, the avoidance action instruction unit 24 may select a combination of the avoidance action A1 of the vehicle 1A and the avoidance action B1 of the vehicle 1B or a combination of the avoidance action A2 of the vehicle 1A and the avoidance action B1 of the vehicle 1B as illustrated in FIG. 8.

Further, the avoidance action instruction unit 24 may set an allowable range of vehicle control of the vehicle 1A, such as the speed and the steering angle, and an allowable range of vehicle control of the vehicle 1B, based on the monitoring information. Then, the avoidance action instruction unit 24 may select a combination of avoidance actions of the vehicle 1A and the vehicle 1B satisfying the allowable range of vehicle control and the allowable range of vehicle control of the vehicle 1B from among the combinations of an avoidance action of the vehicle 1A and an avoidance action of the vehicle 1B.

The description returns to FIG. 6. Next, in Step S211, the avoidance action instruction unit 24 instructs each of the vehicle 1A and the vehicle 1B on an avoidance action related to the selected combination of avoidance actions.

Specifically, when selecting a combination of the avoidance action A1 of the vehicle 1A and the avoidance action B2 of the vehicle 1B, the avoidance action instruction unit 24 instructs the vehicle 1A on the avoidance action A1 and instructs the vehicle 1B on the avoidance action B2.

As described above, the monitoring-control apparatus 20 according to the third example embodiment provides effects similar to those provided by the monitoring-control apparatus 10 according to the second example embodiment.

Further, the monitoring-control apparatus 20 selects avoidance actions of the vehicle 1A and the vehicle 1B, based on a damage evaluation value for an avoidance action of the vehicle 1A and a damage evaluation value for an avoidance action of the vehicle 1B. Accordingly, when controlling avoidance actions of a plurality of vehicles, the monitoring-control apparatus 20 can improve safety inside the plurality of vehicles with degrees of damage to the inside of the plurality of vehicles into consideration.

Note that the present invention is not limited to the aforementioned example embodiments and may be modified as appropriate without departing from the scope and spirit of the present invention.

### <Example of Hardware Configuration>

Each functional component in the monitoring-control apparatus 10 and the monitoring-control apparatus 20 according to the first, second, and third example embodiments may be provided by hardware (such as a hardwired electronic circuit) providing the functional component or may be provided by a combination of hardware and software (such as a combination of an electronic circuit and a program controlling the circuit). The case of each functional component in the aforementioned apparatuses being provided by a combination of hardware and software will be further described below.

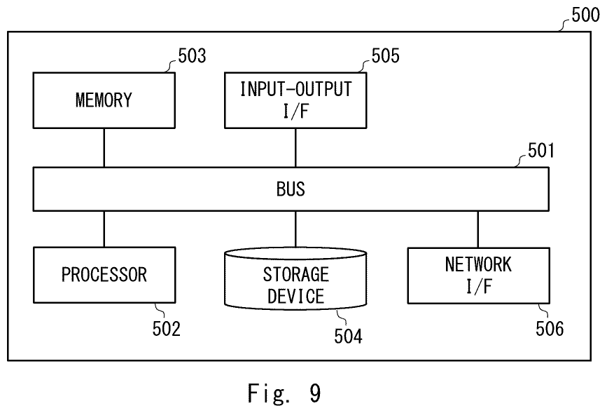

FIG. 9 is a block diagram illustrating a hardware configuration of a computer 500. Each of the monitoring-control apparatus 10 and the monitoring-control apparatus 20 can be provided with the computer 500 including a hardware configuration illustrated in FIG. 9. The computer 500 may be a portable computer such as a smartphone or a tablet terminal, or a stationary computer such as a personal computer (PC). The computer 500 may be a dedicated computer or a general-purpose computer.

For example, by installing a predetermined application on the computer 500, the computer 500 can have a desired function. For example, by installing an application providing each function in the monitoring-control apparatus 10 and the monitoring-control apparatus 20 on the computer 500, the function is provided by the computer 500.

The computer 500 includes a bus 501, a processor 502, a memory 503, a storage device 504, an input-output interface (I/F) 505, and a network interface (I/F) 506. The bus 501 is a data transmission channel for the processor 502, the memory 503, the storage device 504, the input-output interface 505, and the network interface 506 to transmit and receive data to and from each other. Note that the method for interconnecting the processor 502 and other components is not limited to a bus connection.

Examples of the processor 502 include various processors such as a central processing unit (CPU), a graphics processing unit (GPU), and a field-programmable gate array (FPGA). The memory 503 is a main storage provided by using a random-access memory (RAM) or the like. The storage device 504 is an auxiliary storage provided by using a hard disk, a solid-state drive (SSD), a memory card, a read-only memory (ROM), or the like.

The input-output interface 505 is an interface for connecting the computer 500 to input/output devices. For example, the input-output interface 505 is connected to an input device such as a keyboard, and an output device such as a display device.

The network interface 506 is an interface for connecting the computer 500 to a network. The network may be a local area network (LAN) or a wide area network (WAN).

A program for providing a desired function is stored in the storage device 504. The processor 502 provides each function by reading the program into the memory 503 and executing the program.

The program includes an instruction group (or a software code) for causing the computer to perform one or more functions described in the example embodiments when being read into the computer. The program may be stored on a non-transitory computer-readable medium or a tangible storage medium. As an example and not by way of limitation, a computer-readable medium or a tangible storage medium includes a random-access memory (RAM), a read-only memory (ROM), a flash memory, a solid-state drive (SSD), or another memory technology; a CD-ROM, a digital versatile disc (DVD), a Blu-ray (registered trademark) disc, or another optical disk storage; and a magnetic cassette, a magnetic tape, a magnetic disk storage, or another magnetic storage device. The program may be transmitted on a transitory computer-readable medium or a communication medium. As an example and not by way of limitation, a transitory computer-readable medium or a communication medium includes an electric, optical, or acoustic propagation signal, or a propagation signal in another format.

The whole or part of the example embodiments disclosed above may also be described as, but not limited to, the following Supplementary Notes.

### (Supplementary Note 1)

A monitoring-control apparatus including:
a monitoring information acquisition unit configured to acquire monitoring information including at least one item out of vehicle information, intra-vehicular information, and extra-vehicular information of a vehicle being a monitoring target;
an avoidance action formulation unit configured to predict a plurality of avoidance actions for the vehicle to avoid a collision, based on the monitoring information;
a degree-of-damage calculation unit configured to calculate a degree of damage to an inside of the vehicle for each of the plurality of avoidance actions, based on the monitoring information; and
an avoidance action instruction unit configured to select an avoidance action from among the plurality of avoidance actions, based on the degree of damage, and instruct the vehicle on a selected avoidance action.

### (Supplementary Note 2)

The monitoring-control apparatus according to Supplementary Note 1, wherein the avoidance action instruction unit selects an avoidance action with a minimum degree of damage from among the plurality of avoidance actions and instructs the vehicle on a selected avoidance action.

### (Supplementary Note 3)

The monitoring-control apparatus according to Supplementary Note 1 or 2, wherein a degree of damage to an inside of the vehicle includes at least one of
a degree of damage to a person inside the vehicle and
a degree of damage to an object inside the vehicle.

### (Supplementary Note 4)

The monitoring-control apparatus according to any one of Supplementary Notes 1 to 3, wherein
the avoidance action formulation unit determines whether the vehicle can avoid a collision by an avoidance action for each of the plurality of avoidance actions, and,
when the vehicle is determined to be not able to avoid a collision by the avoidance action, the degree-of-damage calculation unit reflects a degree of damage based on the collision in a degree of damage to an inside of the vehicle.

### (Supplementary Note 5)

The monitoring-control apparatus according to any one of Supplementary Notes 1 to 4, wherein
the avoidance action formulation unit defines vehicle control in an avoidance action for each of the plurality of avoidance actions, and
the avoidance action instruction unit sets an allowable range of the vehicle control, based on the monitoring information, and selects an avoidance action satisfying the allowable range from among the plurality of avoidance actions.

### (Supplementary Note 6)

The monitoring-control apparatus according to any one of Supplementary Notes 1 to 5, wherein
vehicles being the monitoring targets include a first vehicle and a second vehicle,
the monitoring information acquisition unit acquires the monitoring information of the first vehicle and the monitoring information of the second vehicle,
the avoidance action formulation unit formulates a plurality of avoidance actions for the first vehicle to avoid a collision with the second vehicle, based on monitoring information of the first vehicle, and formulates a plurality of avoidance actions for the second vehicle to avoid a collision with the first vehicle, based on monitoring information of the second vehicle,
the degree-of-damage calculation unit calculates a degree of damage to an inside of the first vehicle for each of a plurality of avoidance actions of the first vehicle and calculates a degree of damage to an inside of the second vehicle for each of a plurality of avoidance actions of the second vehicle, and
the avoidance action instruction unit selects a combination of avoidance actions from among combinations of an avoidance action of the first vehicle and an avoidance action of the second vehicle, based on a degree of damage to an inside of the first vehicle and a degree of damage to an inside of the second vehicle, and instructs each of the first vehicle and the second vehicle on an avoidance action related to the selected combination of avoidance actions.

### (Supplementary Note 7)

The monitoring-control apparatus according to Supplementary Note 6, wherein the avoidance action instruction unit selects a combination of avoidance actions minimizing a total of a degree of damage to an inside of the first vehicle and a degree of damage to an inside of the second vehicle from among combinations of an avoidance action of the first vehicle and an avoidance action of the second vehicle and instructs each of the first vehicle and the second vehicle on an avoidance action related to the selected combination of avoidance actions.

### (Supplementary Note 8)

The monitoring-control apparatus according to Supplementary Note 6 or 7, wherein
a degree of damage to an inside of the first vehicle includes at least one of
   a degree of damage to a person inside the first vehicle and
   a degree of damage to an object inside the first vehicle, and
a degree of damage to an inside of the second vehicle includes at least one of
   a degree of damage to a person inside the second vehicle and
   a degree of damage to an object inside the second vehicle.

### (Supplementary Note 9)

The monitoring-control apparatus according to any one of Supplementary Notes 6 to 8, wherein
the avoidance action formulation unit determines whether a combination of an avoidance action of the first vehicle and an avoidance action of the second vehicle can avoid a collision between the first vehicle and the second vehicle, and,
when the collision is determined to be unavoidable, the degree-of-damage calculation unit reflects a degree of damage based on the collision in each of a degree of damage to an inside of the first vehicle and a degree of damage to an inside of the second vehicle.

### (Supplementary Note 10)

The monitoring-control apparatus according to any one of Supplementary Notes 6 to 9, wherein
the avoidance action formulation unit defines vehicle control of the first vehicle in an avoidance action for each of a plurality of avoidance actions of the first vehicle and defines vehicle control of the second vehicle in an avoidance action for each of a plurality of avoidance actions of the second vehicle, and
the avoidance action instruction unit sets an allowable range of vehicle control of the first vehicle and an allowable range of vehicle control of the second vehicle, based on the monitoring information, and selects a combination of avoidance actions satisfying an allowable range of vehicle control of the first vehicle and an allowable range of vehicle control of the second vehicle from among combinations of an avoidance action of the first vehicle and an avoidance action of the second vehicle.

### (Supplementary Note 11)

A method including, by a computer:
acquiring monitoring information including at least one item out of vehicle information, intra-vehicular information, and extra-vehicular information of a vehicle being a monitoring target;
predicting a plurality of avoidance actions for the vehicle to avoid a collision, based on the monitoring information;
calculating a degree of damage to an inside of the vehicle for each of the plurality of avoidance actions, based on the monitoring information; and
selecting an avoidance action from among the plurality of avoidance actions, based on the degree of damage, and instructing the vehicle on a selected avoidance action.

### (Supplementary Note 12)

A non-transitory computer-readable medium on which a program is stored, the program causing a computer to execute processing of:
acquiring monitoring information including at least one item out of vehicle information, intra-vehicular information, and extra-vehicular information of a vehicle being a monitoring target;
predicting a plurality of avoidance actions for the vehicle to avoid a collision, based on the monitoring information;
calculating a degree of damage to an inside of the vehicle for each of the plurality of avoidance actions, based on the monitoring information; and
selecting an avoidance action from among the plurality of avoidance actions, based on the degree of damage, and instructing the vehicle on a selected avoidance action.

### REFERENCE SIGNS LIST

1A, 1B VEHICLE
10, 20 MONITORING-CONTROL APPARATUS
11, 21 MONITORING INFORMATION ACQUISITION UNIT
12, 22 AVOIDANCE ACTION FORMULATION UNIT
13, 23 DEGREE-OF-DAMAGE CALCULATION UNIT
14, 24 AVOIDANCE ACTION INSTRUCTION UNIT
500 COMPUTER
501 BUS
502 PROCESSOR
503 MEMORY
504 STORAGE DEVICE
505 INPUT-OUTPUT INTERFACE (I/F)
506 NETWORK INTERFACE (I/F)

What is claimed is:

1. A monitoring-control apparatus comprising:
at least one memory storing instructions, and
at least one processor configured to execute the instructions to:
acquire monitoring information including at least one item out of vehicle information, intra-vehicular information, and extra-vehicular information of a vehicle being a monitoring target;
formulate a plurality of avoidance actions for the vehicle to avoid a collision, based on the monitoring information;
calculate a degree of damage to an inside of the vehicle for each of the plurality of avoidance actions, based on the monitoring information; and
select an avoidance action from among the plurality of avoidance actions, based on the degree of damage, and instruct the vehicle on a selected avoidance action.

2. The monitoring-control apparatus according to claim 1, wherein the at least one processor configured to execute the instructions to select an avoidance action with a minimum degree of damage from among the plurality of avoidance actions and instruct the vehicle on a selected avoidance action.

3. The monitoring-control apparatus according to claim 1, wherein a degree of damage to an inside of the vehicle includes at least one of
a degree of damage to a person inside the vehicle and
a degree of damage to an object inside the vehicle.

4. The monitoring-control apparatus according to claim 1, wherein the at least one processor configured to execute the instructions to:
determine whether the vehicle can avoid a collision by an avoidance action for each of the plurality of avoidance actions; and,
when the vehicle is determined to be not able to avoid a collision by the avoidance action, reflect a degree of damage based on the collision in a degree of damage to an inside of the vehicle.

5. The monitoring-control apparatus according to claim 1, wherein the at least one processor configured to execute the instructions to:
define vehicle control in an avoidance action for each of the plurality of avoidance actions; and
set an allowable range of the vehicle control, based on the monitoring information, and select an avoidance action satisfying the allowable range from among the plurality of avoidance actions.

6. The monitoring-control apparatus according to claim 1, wherein
vehicles being the monitoring targets include a first vehicle and a second vehicle, and
the at least one processor configured to execute the instructions to:
acquire the monitoring information of the first vehicle and the monitoring information of the second vehicle;
formulate a plurality of avoidance actions for the first vehicle to avoid a collision with the second vehicle, based on monitoring information of the first vehicle, and formulate a plurality of avoidance actions for the second vehicle to avoid a collision with the first vehicle, based on monitoring information of the second vehicle;
calculate a degree of damage to an inside of the first vehicle for each of a plurality of avoidance actions of the first vehicle and calculates a degree of damage to an inside of the second vehicle for each of a plurality of avoidance actions of the second vehicle; and
select a combination of avoidance actions from among combinations of an avoidance action of the first vehicle and an avoidance action of the second vehicle, based on a degree of damage to an inside of the first vehicle and a degree of damage to an inside of the second vehicle, and instruct each of the first vehicle and the second vehicle on an avoidance action related to the selected combination of avoidance actions.

7. The monitoring-control apparatus according to claim 6, wherein the at least one processor configured to execute the instructions to select a combination of avoidance actions minimizing a total of a degree of damage to an inside of the first vehicle and a degree of damage to an inside of the second vehicle from among combinations of an avoidance action of the first vehicle and an avoidance action of the second vehicle and instruct each of the first vehicle and the second vehicle on an avoidance action related to the selected combination of avoidance actions.

8. The monitoring-control apparatus according to claim 6, wherein
a degree of damage to an inside of the first vehicle includes at least one of a degree of damage to a person inside the first vehicle and a degree of damage to an object inside the first vehicle, and
a degree of damage to an inside of the second vehicle includes at least one of a degree of damage to a person inside the second vehicle and a degree of damage to an object inside the second vehicle.

9. The monitoring-control apparatus according to claim 6, wherein the at least one processor configured to execute the instructions to:
determine whether a combination of an avoidance action of the first vehicle and an avoidance action of the second vehicle can avoid a collision between the first vehicle and the second vehicle; and,
when the collision is determined to be unavoidable, reflect a degree of damage based on the collision in each of a degree of damage to an inside of the first vehicle and a degree of damage to an inside of the second vehicle.

10. The monitoring-control apparatus according to claim 6, wherein the at least one processor configured to execute the instructions to:
define vehicle control of the first vehicle in an avoidance action for each of a plurality of avoidance actions of the first vehicle and defines vehicle control of the second vehicle in an avoidance action for each of a plurality of avoidance actions of the second vehicle; and
set an allowable range of vehicle control of the first vehicle and an allowable range of vehicle control of the second vehicle, based on the monitoring information, and select a combination of avoidance actions satisfying an allowable range of vehicle control of the first vehicle and an allowable range of vehicle control of the second vehicle from among combinations of an avoidance action of the first vehicle and an avoidance action of the second vehicle.

11. A method comprising, by a computer:
acquiring monitoring information including at least one item out of vehicle information, intra-vehicular information, and extra-vehicular information of a vehicle being a monitoring target;
formulating a plurality of avoidance actions for the vehicle to avoid a collision, based on the monitoring information;
calculating a degree of damage to an inside of the vehicle for each of the plurality of avoidance actions, based on the monitoring information; and
selecting an avoidance action from among the plurality of avoidance actions, based on the degree of damage, and instructing the vehicle on a selected avoidance action.

12. A non-transitory computer-readable medium on which a program is stored, the program causing a computer to execute processing of:
acquiring monitoring information including at least one item out of vehicle information, intra-vehicular information, and extra-vehicular information of a vehicle being a monitoring target;
formulating a plurality of avoidance actions for the vehicle to avoid a collision, based on the monitoring information;
calculating a degree of damage to an inside of the vehicle for each of the plurality of avoidance actions, based on the monitoring information; and
selecting an avoidance action from among the plurality of avoidance actions, based on the degree of damage, and instructing the vehicle on a selected avoidance action.
